(19) United States
(12) Patent Application Publication
(10) Pub. No.: US 2005/0264195 A1
(43) Pub. Date: Dec. 1, 2005

(54) Plasma display panel

(76) Inventors: Hoon-Young Choi, Suwon-si (KR); Takahisa Mizuta, Suwon-si (KR)

Correspondence Address: MCGUIREWOODS, LLP, 1750 TYSONS BLVD, SUITE 1800, MCLEAN, VA, 22102, US

(21) Appl. No.: 11/110,867

(22) Filed: Apr. 21, 2005

(30) Foreign Application Priority Data
May 31, 2004 (KR) 10-2004-0038932

(51) Int. Cl. H01J 17/49

(52) U.S. Cl. 313/582

(57) ABSTRACT

A plasma display panel including a first substrate and a second substrate opposing one another with a gap therebetween, barrier ribs formed in the gap to define a plurality of discharge cells, address electrodes formed along a first direction on the first substrate, and display electrodes formed on the first substrate along a second direction that is substantially perpendicular to the first direction. The address electrodes are insulated from the display electrodes. The address electrodes are closer to the discharge cells than are the display electrodes.

### CROSS REFERENCE TO RELATED APPLICATION

This application claims priority to and the benefit of Korean Patent Application No. 10-2004-0038932, filed on May 31, 2004, which is hereby incorporated by reference for all purposes as if fully set forth herein.

### BACKGROUND OF THE INVENTION

1. Field of the Invention

The present invention relates to an energy efficient plasma display panel (PDP).

2. Discussion of the Background Art

Generally, a PDP displays images through excitation of phosphors by plasma discharge. That is, vacuum ultraviolet (VUV) rays emitted from plasma obtained via gas discharge excite phosphor layers, which then emit visible red (R), green (G), and blue (B) light is to thereby form images. The PDP has many advantages including it may have screen sizes greater than 60 inches, a thin profile of 10 cm or less, a wide viewing angle and good color reproduction due to its self-emissive nature. Further, PDPs may be easier and cheaper to manufacture than liquid crystal displays (LCDs). Consequently, the PDP is gaining popularity at home and in industry.

In a conventional alternating current (AC) PDP, a rear substrate and a front substrate are sealed together with a predetermined gap therebetween. A plurality of stripe-shaped address electrodes may be formed along a first direction on a surface of the rear substrate facing the front substrate. A first dielectric layer covers the address electrodes, and a plurality of barrier ribs are formed on the first dielectric layer. The barrier ribs may be formed in a stripe pattern along the first direction and in between adjacent address electrodes. Red, green, and blue phosphor layers are respectively formed on the first dielectric layer and the sides of the barrier ribs.

A plurality of display electrode pairs, where each display electrode comprises a transparent electrode and a metallic bus electrode, are formed on a surface of the front substrate facing the rear substrate. A second dielectric layer covers the display electrodes, and a protection layer, which may be formed of magnesium oxide (MgO), covers the second dielectric layer.

The area at an intersection between an address electrode and a display electrode pair forms a discharge cell. Millions of discharge cells may be formed in a matrix configuration by such an arrangement.

A memory characteristic is utilized to simultaneously drive the AC PDP's millions of discharge cells. More specifically, to generate a discharge between an X electrode and a Y electrode comprising each display electrode pair, a potential difference of at least a predetermined voltage, which is referred to as a firing voltage Vf, must exist between them. Applying an address voltage Va between a Y electrode and an address electrode generates an address discharge that creates plasma in the corresponding discharge cell. Electrons and ions in the plasma migrate toward the electrode of opposite polarity, thereby creating the flow of current.

Most of the migrated space charges accumulate on the first and second dielectric layers, which cover the address and display electrodes, respectively, and are opposite in polarity. The result is that a net space potential between the Y electrode and the address electrode becomes less than the originally applied address voltage Va, thereby weakening and then terminating the address discharge. At this time, a relatively small number of electrons may accumulate toward the X electrode, while a relatively large number of ions may accumulate toward the Y electrode. The charge accumulated on the second dielectric layer, which covers the X and Y electrodes, is referred to as a wall charge Qw, while the space voltage formed between the X and Y electrodes by the wall charge Qw, is referred to as a wall voltage Vw.

Subsequently, when applying a discharge sustain voltage Vs between the X electrode and the Y electrode, if a sum of the discharge sustain voltage Vs and the wall voltage Vw (Vs+Vw) exceeds the firing voltage Vf, a sustain discharge occurs in the corresponding discharge cell. The discharge generates VUV rays that excite the corresponding phosphor layer to emit visible light through the transparent front substrate.

However, when the address discharge between the Y electrode and the address electrode (i.e., when there is no application of an address voltage Va) does not occur, a wall charge does not exist between the X and Y electrodes, and, ultimately, a wall voltage also does not exist between the same. Consequently, during a sustain discharge period, only the discharge is sustain voltage Vs will be applied between the X and Y electrodes, and since this voltage alone does not exceed the firing voltage Vf, no sustain discharge occurs.

Driving the PDP as described above involves many steps between power input and generating visible light. Further, the efficiency of converting energy in each of these steps may be low. Therefore, the conventional CRT may have better overall efficiency (brightness to power consumption ratio) than the PDP. The conventional PDP's low energy efficiency is a serious drawback of this display configuration.

### SUMMARY OF THE INVENTION

The present invention provides a PDP that enables address discharge at low voltages, thereby reducing the PDP's power consumption.

Additional features of the invention will be set forth in the description which follows, and in part will be apparent from the description, or may be learned by practice of the invention.

The present invention discloses a PDP including a first substrate and a second substrate opposing one another with a gap therebetween, barrier ribs formed in the gap to define a plurality of discharge cells, address electrodes formed on the first substrate and along a first direction, and display electrodes formed on the first substrate and along a second direction that is substantially perpendicular to the first direction. The address electrodes are insulated from the display electrodes. The address electrodes are closer to the discharge cells than are the display electrodes.

The present invention also discloses a PDP comprising a first substrate opposing a second substrate, a plurality of discharge cells between the first substrate and the second substrate, and a plurality of first electrodes, a plurality of second electrodes, and a plurality of third electrodes formed on the same substrate. A discharge cell is addressed by a discharge between a first electrode and a second electrode, and the discharge cell is sustain discharged by a discharge between the second electrode and a third electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partly cutaway partial perspective view of a PDP according to a first exemplary embodiment of the present invention.

FIG. 2 is a sectional view taken along line A-A of FIG. 1.

FIG. 3 is a partial plan view of the PDP of FIG. 1.

FIG. 4 is a partial plan view of a PDP according to a second exemplary embodiment of the present invention.

FIG. 5 is a sectional view taken along line B-B of FIG. 4.

### DETAILED DESCRIPTION OF THE ILLUSTRATED EMBODIMENTS

Exemplary embodiments of the present invention will now be described with reference to the drawings.

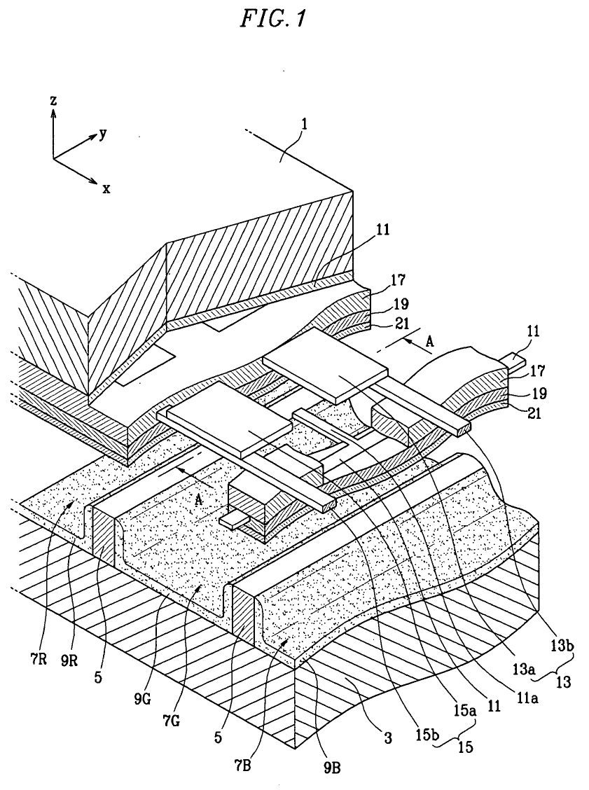

FIG. 1 is a partly cutaway partial perspective view of a PDP according to a first exemplary embodiment of the present invention.

Referring to FIG. 1, the PDP according to the first exemplary embodiment of the present invention may include a first substrate 1 and a second substrate 3 sealed opposing one another with a predetermined gap therebetween. An inert gas is filled in the gap between the first substrate 1 and the second substrate 3, and a plurality of barrier ribs 5 may be mounted in the gap. Stripe-shaped barrier ribs 5 may be formed extending substantially along a first direction (i.e., along direction y) and at predetermined intervals, thereby defining a plurality of discharge cells 7R, 7G, 7B between adjacent barrier ribs 5. A plurality of red (R), green (G), and blue (B) phosphor layers 9R, 9G, 9B may be formed in the discharge cells 7R, 7G, 7B, respectively.

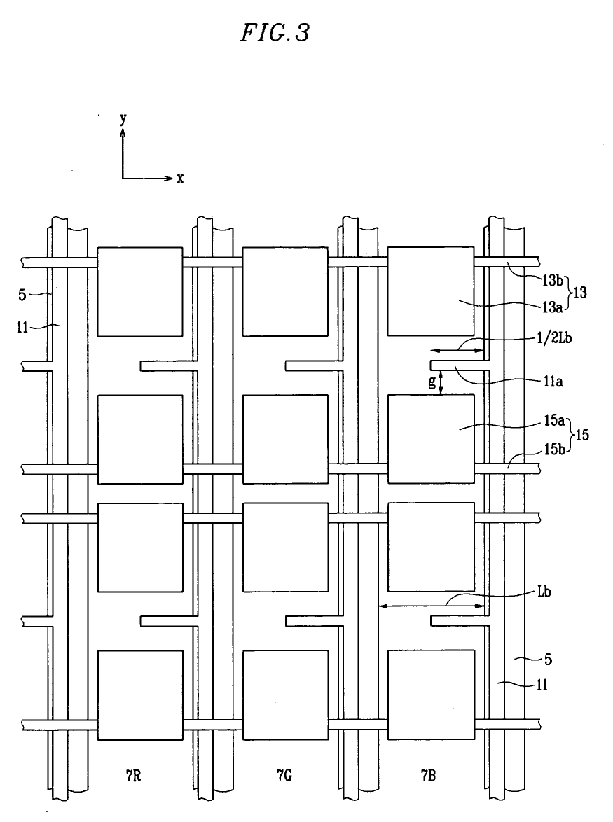

Referring also to FIG. 3, a plurality of address electrodes 11 may be formed on the first substrate 1 substantially along the first direction. The address electrodes 11 may be formed in a stripe pattern and at locations corresponding to the barrier ribs 5. A plurality of display electrodes 13, 15 may be formed on the first substrate I substantially along a second direction (i.e., along direction x), which is substantially perpendicular to the first direction. Pairs of the display electrodes 13, 15 may be provided at intervals corresponding substantially to lengths of the discharge cells 7R, 7G, 7B along direction y.

Each address electrode 11 has a first long edge proximate to a long edge of a corresponding barrier rib 5. With widths of the address electrodes 11 and the barrier ribs 5 being formed along direction x, a second long edge of each address electrode 11, which is opposite the first long edge, may extend approximately to a center of the width of the corresponding barrier rib 5 without extending past the same. Such a configuration may prevent mis-discharge between adjacent discharge cells 7R, 7G, 7B along direction x.

The present invention is not limited to the stripe-shaped barrier ribs 5 described above, and other barrier rib structures may be used. For example, the barrier ribs 5 may comprise first barrier rib members (not shown) formed along direction x and second barrier rib members (not shown) formed along direction y in a closed, or matrix, type of configuration defining substantially rectangular shaped discharge cells 7R, 7G, 7B. The barrier ribs 5 may also be formed so that they define discharge cells 7R, 7G, 7B having other closed shapes, such as, for example, a hexagon or an octagon.

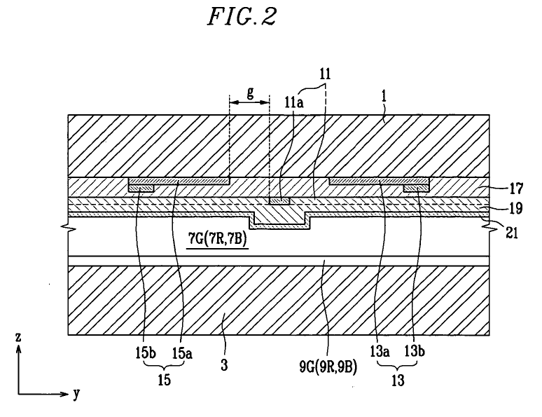

FIG. 2 is a sectional view taken along line A-A of FIG. 1. The relative formations of the address electrodes 11 and the display electrodes 13, 15 will be described below with reference to FIG. 2 in combination with FIG. 1 and FIG. 3.

The address electrodes 11 are insulated from the display electrodes 13, 15, and they are closer to the discharge cells 7R, 7G, 7B in a third direction substantially normal to the planes formed by the first and second substrates 1, 3, (i.e., along direction z), as best shown in FIG. 2. Stated differently, the display electrodes 13, 15 may be formed on the first substrate 1, and then the address electrodes 11 may be formed on the first substrate 1 over, and insulated from, the display electrodes 13, 15.

The display electrodes 13, 15 may comprise first electrodes 13 (X electrodes) and second electrodes 15 (Y electrodes). The Y electrodes 15 effect an address discharge with the address electrodes 11, and then they effect a sustain discharge with the X electrodes in the discharge cells 7R, 7G, 7B following the address discharge. The X and Y electrodes 13, 15 may comprise bus electrodes 13b, 15b, and transparent electrodes 13a, 15a, respectively. The transparent electrodes 13a, 15a may extend from a bus electrode 13b, 15b toward centers of the corresponding discharge cells 7R, 7G, 7B, and the bus electrodes 13b, 15b supply current to the transparent electrodes 13a, 15b, respectively. Alternatively, the X and Y electrodes 13, 15 may be formed without the transparent electrodes 13a, 15a or without the bus electrodes 13b, 15b.

The transparent electrodes 13a, 15a effect plasma surface discharge in the discharge cells 7R, 7G, 7B, and they may be formed using, for example, indium tin oxide (ITO) to ensure brightness of the PDP. The bus electrodes 13b, 15b may be made of a metallic material to compensate for the high resistance of the transparent electrodes 13a, 15a, thereby improving conductivity of the X and Y electrodes 13, 15.

The X and Y electrodes 13, 15 may be provided in pairs such that a bus electrode 13b of each pair extends along one end of each discharge cell 7R, 7G, 7B of a particular row of the same along direction x, and a bus electrode 15b extends along an opposite end of each discharge cell 7R, 7G, 7B of the same row. Further, a transparent electrode 13a and a transparent electrode 15a are provided opposing one another in each discharge cell 7R, 7G, 7B. A first dielectric layer 17 covers the X and Y electrodes 13, 15, thereby enabling the formation of a wall charge to thereby effect address discharge and sustain discharge.

To form wall charges in the discharge cells 7R, 7G, 7B and effect address discharge with the Y electrodes 15, the address electrodes 11 may be formed on the first dielectric layer 17, and they may be covered by a second dielectric layer 19 and a protection layer 21, which may be made of MgO. The first and second dielectric layers 17, 19 may be formed of transparent dielectric materials so that visible light can pass through them. Further, the first and second dielectric layers 17, 19 may made of a similar dielectric material to allow distortionless transmission of visible light.

In greater detail, the transparent electrodes 13a, 15a may be aligned in rows along direction x on the first substrate 1, and the bus electrodes 13b, 15b may extend along direction x over ends of the transparent electrodes 13a, 15a of a corresponding row of the same. The first dielectric layer 17 covers the transparent electrodes 13a, 15a and the bus electrodes 13b, 15b, and the address electrodes 11 may be formed on the first dielectric layer 17. The second dielectric layer 19 covers the address electrodes 11, and the protection layer 21 covers the second dielectric layer 19. Consequently, the first substrate 1 may have a stacked structure sequentially comprising the X and Y electrodes 13, 15, the first dielectric layer 17, the address electrodes 11, the second dielectric layer 19, and the protection layer 21.

As a result of this stacked structure, the address electrodes 11 may be formed on the first substrate 1 and separated by a gap g, (i.e., an address discharge gap), from the Y electrodes 15. Accordingly, an address voltage required for an address discharge may decrease, which reduces the amount of power consumed for address discharge and, ultimately, by the PDP.

Furthermore, the address electrodes 11 are closer to the discharge cells 7R, 7G, 7B than are the X and Y electrodes 13, 15. That is, the address electrodes 11, the second dielectric layer 19, and the protection layer 21 protrude toward centers of the discharge cells 7R, 7G, 7B, and a long gap between the X electrodes and the Y electrodes 13, 15 and the discharge cells 7R, 7G, 7B equals the degree of protrusion, thereby enhancing discharge efficiency.

The address electrodes 11 may be formed in a stripe pattern on the first dielectric layer 17 and at locations corresponding to the barrier ribs 5, as described above. Each address electrode 11 may include a plurality of branches 11a, each of which extends toward the center of a corresponding discharge cell 7R, 7G, 7B. The branches 11a function to further reduce the voltage required for an address discharge. The branches 11a may be closer to the Y electrodes 15, which operate during address discharge, than to the X electrodes 13. That is, the branches 11a may be closer to the corresponding transparent electrodes 15a than to the corresponding transparent electrodes 13a. In FIG. 3, however, the branches 11a are shown extending approximately in the middle of adjacent pairs of the X and Y electrodes 13a, 15a.

The branches 11a increase an opposing surface with the transparent electrodes 15a of the Y electrodes 15. To accomplish this without causing mis-discharge between adjacent pairs of the discharge cells 7R, 7G, 7B, a distal end of the branches 11a may extend into a discharge cell as far as one-half a length Lb between adjacent barrier ribs 5 (i.e., a width of the discharge cells 7R, 7G, 7B). Increasing the opposing surface with the transparent electrodes 15a may provide for more efficient address discharge between the address electrodes 11 and the Y electrodes 15.

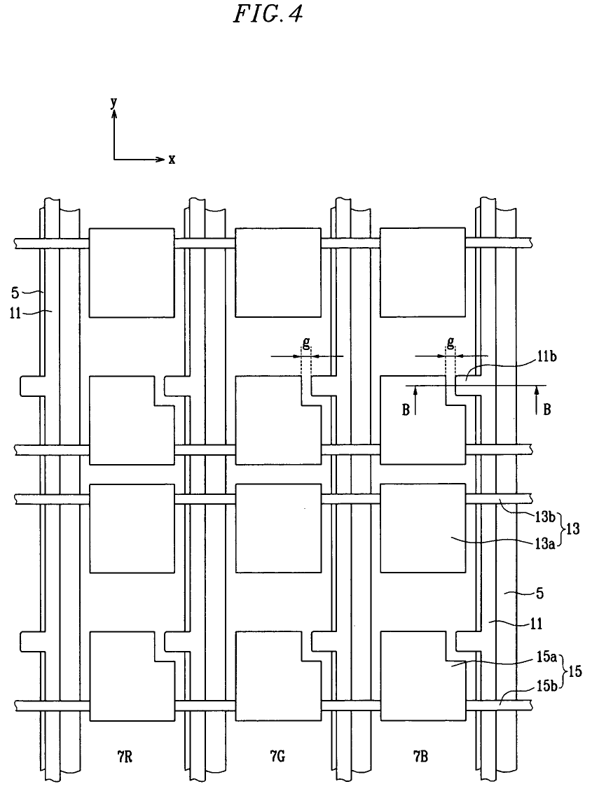

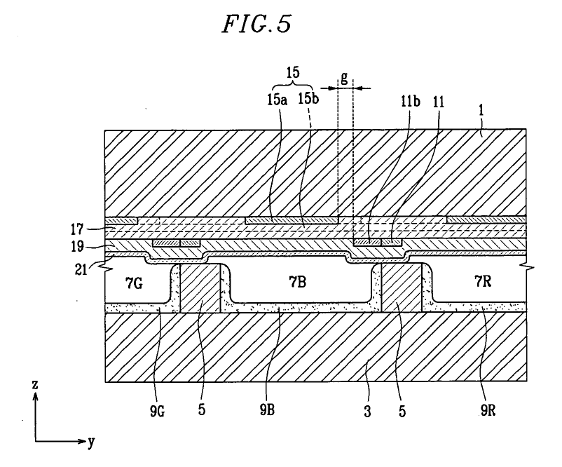

FIG. 4 is a partial plan view of a PDP according to a second exemplary embodiment of the present invention, and FIG. 5 is a sectional view taken along line B-B of FIG. 4.

The second exemplary embodiment is similar to the first exemplary embodiment. Hence, different aspects between the two exemplary embodiments will be described below.

In the second exemplary embodiment, projections 11b of the address electrodes 11 protrude toward the transparent electrodes 15a of the Y electrodes 15. Further, the transparent electrodes 15a may be formed having a cutaway segment that is removed to accommodate the projections 11b while maintaining an address discharge gap g with the projections 11b. That is, the projections 11b extend from the address electrodes 11 toward the cutaway segments of the transparent electrodes 15a, and the address discharge gap g is formed between a distal end of the projections 11b and the corresponding adjacent transparent electrodes 15a along direction x. The is address discharge gap g of the second exemplary embodiment may be less than the address discharge gap g of the first exemplary embodiment shown in FIG. 2 and FIG. 3.

As described above, the address electrodes may be formed with branches or projections to decrease an address discharge gap between the address electrodes and Y electrodes. The decreased address discharge gap reduces an amount of voltage required for an address discharge. Therefore, the PDP may be driven with less power.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel (PDP), comprising:
a first substrate and a second substrate opposing one another with a gap therebetween;
barrier ribs formed in the gap to define a plurality of discharge cells;
address electrodes formed on the first substrate and along a first direction; and
display electrodes formed on the first substrate and along a second direction that is substantially perpendicular to the first direction,
wherein the address electrodes are insulated from the display electrodes, and
wherein the address electrodes are closer to the discharge cells than are the display electrodes.

2. The PDP of claim 1, further comprising:
a first dielectric layer; and
a second dielectric layer,
wherein the display electrodes are covered by the first dielectric layer, and
wherein the address electrodes are formed on the first dielectric layer and are covered by the second dielectric layer.

3. The PDP of claim 1, wherein the barrier ribs are formed along the first direction, and
wherein an address electrode includes branches extending toward the display electrodes.

4. The PDP of claim 3, wherein the display electrodes comprise first electrode and second electrode pairs, and a branch extends in a space between a first electrode and a second electrode.

5. The PDP of claim 3, wherein a distal end of the branches extends into a discharge cell not farther than one-half a length between adjacent barrier ribs.

6. The PDP of claim 1, wherein the barrier ribs are formed along the first direction, and
wherein an address electrode includes protrusions extending toward the display electrodes.

7. The PDP of claim 6, wherein the display electrodes comprise first electrode and second electrode pairs, and a protrusion extends toward a second electrode.

8. The PDP of claim 7, wherein the second electrode has a cutaway segment at an area corresponding to the protrusion.

9. The PDP of claim 1, wherein an address electrode has a first long edge proximate to a long edge of a corresponding barrier rib, and with widths of the address electrode and the corresponding barrier rib being formed along the second direction, a second long edge of the address electrode opposite to the first long edge extends at most to a center of the width of the corresponding barrier rib.

10. The PDP of claim 1, wherein the address electrodes extend toward the discharge cells.

11. The PDP of claim 1, further comprising:
a first dielectric layer; and
a second dielectric layer,
wherein the display electrodes include bus electrodes extending in the second direction and transparent electrodes extending from the bus electrodes,
wherein the bus electrodes and the transparent electrodes are formed on the first substrate and are covered by the first dielectric layer, and
wherein the address electrodes are formed on the first dielectric layer and are covered by the second dielectric layer.

12. A plasma display panel (PDP), comprising:
a first substrate opposing a second substrate;
a plurality of discharge cells between the first substrate and the second substrate; and
a plurality of first electrodes, a plurality of second electrodes, and a plurality of third electrodes formed on the same substrate,
wherein a discharge cell is addressed by a discharge between a first electrode and a second electrode, and
wherein the discharge cell is sustain discharged by a discharge between the second electrode and a third electrode.

13. The PDP of claim 12, further comprising a plurality of barrier ribs between the first substrate and the second substrate, wherein the barrier ribs define the discharge cells.

14. The PDP of claim 12, further comprising:
a first dielectric layer; and
a second dielectric layer,
wherein the first dielectric layer covers the second electrode and the third electrode,
wherein the first electrode is formed on the first dielectric layer and the second dielectric layer covers the first electrode, and
wherein the first electrode is closer to the discharge cells than are the second electrode and the third electrode.

15. The PDP of claim 12, wherein a discharge cell comprises the first electrode, the second electrode, and the third electrode, and
wherein the first electrode is closer to the second electrode than to the third electrode.
